(19) United States
(12) Patent Application Publication
(10) Pub. No.: US 2009/0150234 A1
(43) Pub. Date: Jun. 11, 2009

(54) Electronic Coupon Validation For A Point Of Sale ('POS') Transaction

(75) Inventors: Thomas J. Darst, Raleigh, NC (US); Robert J. Noll, Youngstown, OH (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, Armonk, NY (US)

(21) Appl. No.: 11/953,387

(22) Filed: Dec. 10, 2007

(51) Int. Cl. G06Q 30/00

(52) U.S. Cl. 705/14; 705/17

(57) ABSTRACT

Methods, apparatus, and products are disclosed for electronic coupon validation for a Point Of Sale (‘POS’) transaction that include: maintaining, by a POS module, a product coupon participation table that associates each of a plurality of electronic coupons with one or more items which qualify for that electronic coupon; identifying, by the POS module, a plurality of purchase items for a POS transaction; generating, by the POS module, a transaction coupon list in dependence upon the product coupon participation table and the plurality of purchase items; receiving, by the POS module, an electronic customer coupon; determining, by the POS module, whether the electronic customer coupon is specified in the transaction coupon list; and applying, by the POS module, the electronic customer coupon to the POS transaction if the electronic customer coupon is specified in the transaction coupon list.

### BACKGROUND OF THE INVENTION

1. Field of the Invention

The field of the invention is data processing, or, more specifically, methods, apparatus, and products for electronic coupon validation for a Point Of Sale (‘POS’) transaction.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems and networks today that are much more ubiquitous and powerful than just a few years ago.

One of the most prevalent uses of these powerful computer systems and networks is for Point Of Sale (‘POS’) systems in retail establishments such as, for example, stores, restaurants, hotels, stadiums, casinos, and so on. Modern POS systems typically include one or more POS terminals connected to a POS server that aggregates and administers POS transaction data. Each POS terminal is typically located on a checkout counter and used by an operator to complete customer sales. Each POS terminal is a computing device that typically includes a cash register, check/debit card/credit card reader, bar code reader or radio frequency identification (‘RFID’) chip reader, and so on. The POS terminals communicate over a network to various external transaction systems such as, for example, credit card processing systems, debit card processing systems, check processing systems, and so on.

To entice customers to purchase a particular product at a retail establishment, product manufacturers or distributors often provide customers with a coupon that entitle the customer to purchase the particular product at a discounted price. A customer traditionally receives the discount on the item purchased by clipping a paper coupon from a newspaper or magazine insert and subsequently presenting the paper coupon to a cashier at a POS terminal. Because the validation of paper coupons is a CPU-intensive activity, customer presentation of paper coupons could potentially be a bottleneck for moving customers through a POS system. Currently, however, performance degradation in a POS system has been limited by factors that constrain the number of coupons presented by customers at a POS terminal. A major factor that constrains the number of coupons presented by customers is that customers typically have a behavior pattern of pre-selecting from among a collection of paper coupons only those coupons that apply to products which the customer intends to purchase. This culling technique results in a very high redemption rate for paper coupons presented at a POS terminal.

As computers have become more and more ubiquitous throughout society, the use of electronic coupons is rapidly replacing the use of traditional paper coupons. Rather than presenting paper coupons at a POS terminal, a customer may present a transportable storage device from which the POS terminal may download the customer's collection of coupons or the customer may present authentication credentials that allow the POS terminal to download the customer's collection of coupons from a coupon repository. In contrast to presenting paper coupons, however, customers typically do not have a behavior pattern of pre-selecting from the customer's coupon collection only those coupons that apply to products which the customer intends to purchase. Rather, customers typically present their entire collection of electronic coupons to the POS terminal and rely on the POS terminal to properly apply any relevant coupons to the POS transaction. As electronic coupons become more and more popular, the number of such electronic coupons will proliferate, especially as Internet coupon brokers such as Google or AOL provide the ability of coupon issuers to create electronic coupons targeted toward an individual's buying patterns. This increasing number of electronic coupons available to customers will have a negative performance impact on POS systems, thereby decreasing customer satisfaction with their shopping experiences. As such, readers will appreciate that room for improvement exists in electronic coupon validation for a POS transaction.

### SUMMARY OF THE INVENTION

Methods, apparatus, and products are disclosed for electronic coupon validation for a Point Of Sale (‘POS’) transaction that include: maintaining, by a POS module, a product coupon participation table that associates each of a plurality of electronic coupons with one or more items which qualify for that electronic coupon; identifying, by the POS module, a plurality of purchase items for a POS transaction; generating, by the POS module, a transaction coupon list in dependence upon the product coupon participation table and the plurality of purchase items; receiving, by the POS module, an electronic customer coupon; determining, by the POS module, whether the electronic customer coupon is specified in the transaction coupon list; and applying, by the POS module, the electronic customer coupon to the POS transaction if the electronic customer coupon is specified in the transaction coupon list.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a functional block diagram of an exemplary system capable of electronic coupon validation for a POS transaction according to embodiments of the present invention.

FIG. 2 sets forth a flow chart illustrating an exemplary method of electronic coupon validation for a POS transaction according to embodiments of the present invention.

FIG. 3 sets forth a flow chart illustrating a further exemplary method of electronic coupon validation for a POS transaction according to embodiments of the present invention.

FIG. 4 sets forth a flow chart illustrating a further exemplary method of electronic coupon validation for a POS transaction according to embodiments of the present invention.

FIG. 5 sets forth a flow chart illustrating a further exemplary method of electronic coupon validation for a POS transaction according to embodiments of the present invention.

### DETAILED DESCRIPTION OF EXEMPLARY EMBODIMENTS

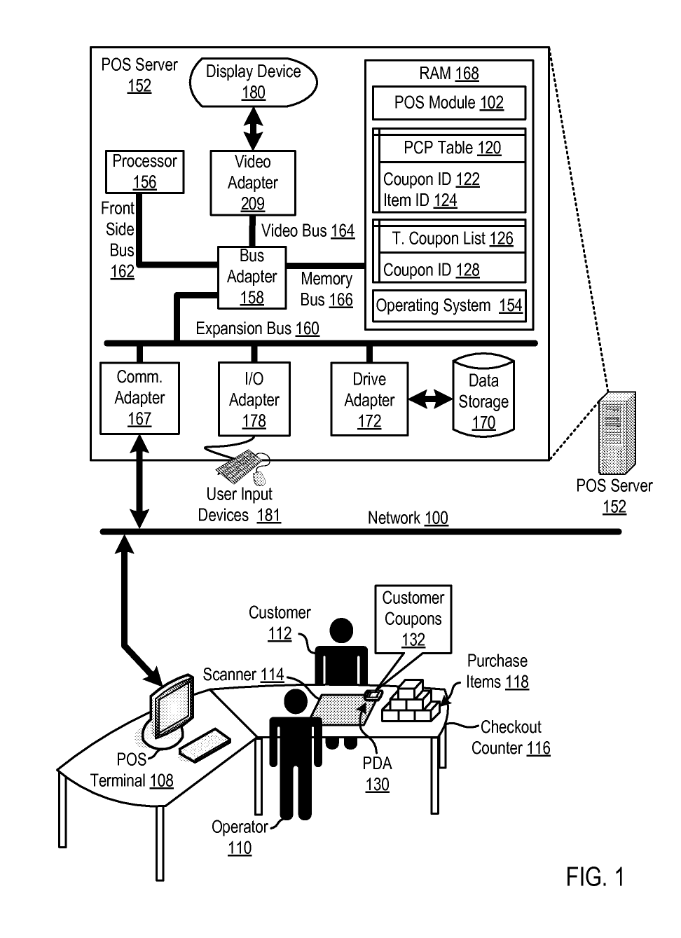

Exemplary methods, apparatus, and products for electronic coupon validation for a POS transaction in accordance with the present invention are described with reference to the accompanying drawings, beginning with FIG. 1. FIG. 1 sets forth a functional block diagram of an exemplary system capable of electronic coupon validation for a POS transaction according to embodiments of the present invention. The exemplary system of FIG. 1 includes a POS terminal (108) and a POS server (152) connected together for data communications through a network (100).

The exemplary POS terminal (108) of FIG. 1 is a computing device used by an operator (110) to complete transactions for a customer (112) at a checkout counter (116). The POS terminal (108) of FIG. 1 includes user input devices such as, for example, a keyboard, touch screen, microphone, and so on. The POS terminal (108) also includes a scanner (114) capable of identifying purchase items (118) using a barcode, RFID tag, or any other technology as will occur to those of skill in the art. Examples of POS terminals that may be improved for electronic coupon validation for a POS transaction according to embodiments of the present invention include Toshiba's ST-7000 Modular POS Terminal, IBM's SurePOS™ 700 series of POS terminals, NCR's 7452-3500 POS terminal, and so on.

The exemplary POS server (152) of FIG. 1 is a computing device that manages one or more POS terminals. The POS server (152) of FIG. 1 aggregates and administers POS transaction data received from and provided to each of the POS terminals. In the example of FIG. 1, the POS server (152) may serve as a gateway through which all POS transaction data passes before being processes by other external payment processing systems such as, for example, check processing systems, debit card processing systems, credit card processing systems, and so on. In other embodiments, however, each POS terminal may communicate through a network directly with various external payment processing systems and provide the results of those communications to the POS server (152) for storage. In still further embodiments, the POS terminal may be a stand-alone unit that does not rely on a POS server and the POS module may be installed on the POS terminal.

The exemplary POS server (152) of FIG. 1 includes a POS module (102) stored in RAM (168). The POS module (102) is a software component having computer program instructions for electronic coupon validation for a POS transaction according to embodiments of the present invention. An electronic coupon is a data structure that represents a traditional coupon entitling a customer to a financial discount or rebate when purchasing a particular item. The POS module (102) operates generally for electronic coupon validation for a POS transaction according to embodiments of the present invention by: maintaining a product coupon participation (‘PCP’) table (120) that associates each of a plurality of electronic coupons with one or more items which qualify for that electronic coupon; identifying a plurality of purchase items for a POS transaction; generating a transaction coupon list (126) in dependence upon the product coupon participation table (120) and the plurality of purchase items; receiving an electronic customer coupon (132); determining whether the electronic customer coupon (132) is specified in the transaction coupon list (126); and applying the electronic customer coupon (132) to the POS transaction if the electronic customer coupon (132) is specified in the transaction coupon list (126). Although the POS module (102) is depicted in FIG. 1 as being installed upon the POS Server (152), readers will note that such an example is for explanation only and not for limitation. In fact, in some embodiments, the POS module (102) may be installed directly on the POS terminal (108).

The exemplary product coupon participation table (120) of FIG. 1 associates electronic coupons with items which qualify for the electronic coupons. Each record of the exemplary product coupon participation table (120) of FIG. 1 includes a coupon identifier field (122) and an item identifier field (124). The coupon identifier field (122) stores an identifier for an electronic coupon. The item identifier field (124) stores an identifier for an item which qualifies for the electronic coupon specified by the associated coupon identifier (122). An item is typically associated with a particular electronic coupon in the product coupon participation table (120) because the item qualifies for a price discount if the coupon criteria are satisfied. For example, consider a coupon that provides a price discount on a particular soft drink if the customer purchases a bag of chips. In such an example, the item identifier for the particular soft drink may be associated with the coupon identifier for the electronic coupon providing the price discount.

The transaction coupon list (126) of FIG. 1 is a list that specifies the coupons that are applicable to the items being purchased by a customer in a POS transaction. The exemplary transaction coupon list (126) of FIG. 1 includes a coupon identifier field (128). The coupon identifier field (128) stores the coupon identifier for a coupon associated in the product coupon participation table (120) with an item being purchased by the customer in the particular POS transaction.

The POS module (102) may maintain the product coupon participation table (120) with information received from a product coupon participation provider. A product coupon participation provider may be a coupon broker, a coupon issuer, or any other entity involved in the creating, distributing, and redeeming electronic coupons. The product coupon participation provider provides the POS module (102) with information that relates a particular coupon to a particular item. In the example of FIG. 1, the POS module may maintain the product coupon participation table (120) by: receiving, from a product coupon participation provider, a coupon identifier for an electronic coupon; receiving, from the product coupon participation provider, one or more item identifiers for the items which qualify for the electronic coupon specified by the coupon identifier; and storing, in the product coupon participation table (120), the coupon identifier in association with the one or more item identifiers.

In other embodiments, the POS module (102) may derive the information stored in the product coupon participation table (120) from coupons that the POS module (102) receives from a coupon issuer or coupon broker. In such other embodiments, the POS module may maintain the product coupon participation table (120) by: receiving an electronic coupon having a coupon definition; parsing the coupon definition for one or more item identifiers for the items which qualify for the electronic coupon; and storing, in the product coupon participation table, a coupon identifier for the electronic coupon in association with the one or more item identifiers.

In the example of FIG. 1, when the customer (112) finalizes the POS transaction at the checkout counter (116), the POS module (102) receives the electronic customer coupons (132) from a Personal Digital Assistant (‘PDA’) (130) of the customer (112). The POS module (102) receives the electronic customer coupons (132) through the POS terminal (108), which establishes a wireless data communications connection with the PDA (130). Readers will note, however, that such an example is for explanation and not for limitation. In some other embodiments, the POS module (102) may retrieve the electronic customer coupons (132) from a coupon repository connected to the POS server (152) through a data communications connection. A coupon repository serves as network-accessible storage for the electronic customer coupons for a customer. The POS module (102) may identify a particular customer's electronic coupons to retrieve from a coupon repository using authentication credentials provided to the POS module (102) by the customer (112) through the POS terminal (108).

Also stored in POS server's RAM (168) is an operating system (154). Operating systems useful for electronic coupon validation for a POS transaction according to embodiments of the present invention include UNIX™, Linux™, Microsoft Vista™, AIX™, IBM's i5/OS™, IBM's 4690 OS, and others as will occur to those of skill in the art. The operating system (154), the POS module (102), the product coupon participation table (120), and the transaction coupon list (126) in the example of FIG. 1 are shown in RAM (168), but many components of such software typically are stored in non-volatile memory also, such as, for example, on a disk drive (170).

The exemplary POS server (152) of FIG. 1 includes disk drive adapter (172) coupled through expansion bus (160) and bus adapter (158) to processor (156) and other components of the POS server (152). Disk drive adapter (172) connects non-volatile data storage to the POS server (152) in the form of disk drive (170). Disk drive adapters useful in computing devices for electronic coupon validation for a POS transaction according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (‘EEPROM’ or ‘Flash’ memory), RAM drives, and so on, as will occur to those of skill in the art.

The example POS server (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example POS server (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary POS server (152) of FIG. 1 includes a communications adapter (167) that couples the computing device for data communications with other servers in the data center through a data communications network (100). Such a data communication network (100) may be implemented with external buses such as a Universal Serial Bus (‘USB’), or as an Internet Protocol (‘IP’) network or an Ethernet network, an I²C network, a System Management Bus (‘SMBus’), an Intelligent Platform Management Bus (‘IPMB’), for example, and in other ways as will occur to those of skill in the art. Communications adapters implement the hardware level of data communications through which one computer sends data communications to another computer, directly or through a data communications network. Examples of communications adapters useful for electronic coupon validation for a POS transaction according to embodiments of the present invention include modems for wired dial-up communications, Ethernet (IEEE 802.3) adapters for wired data communications network communications and 802.11 adapters for wireless data communications network communications.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

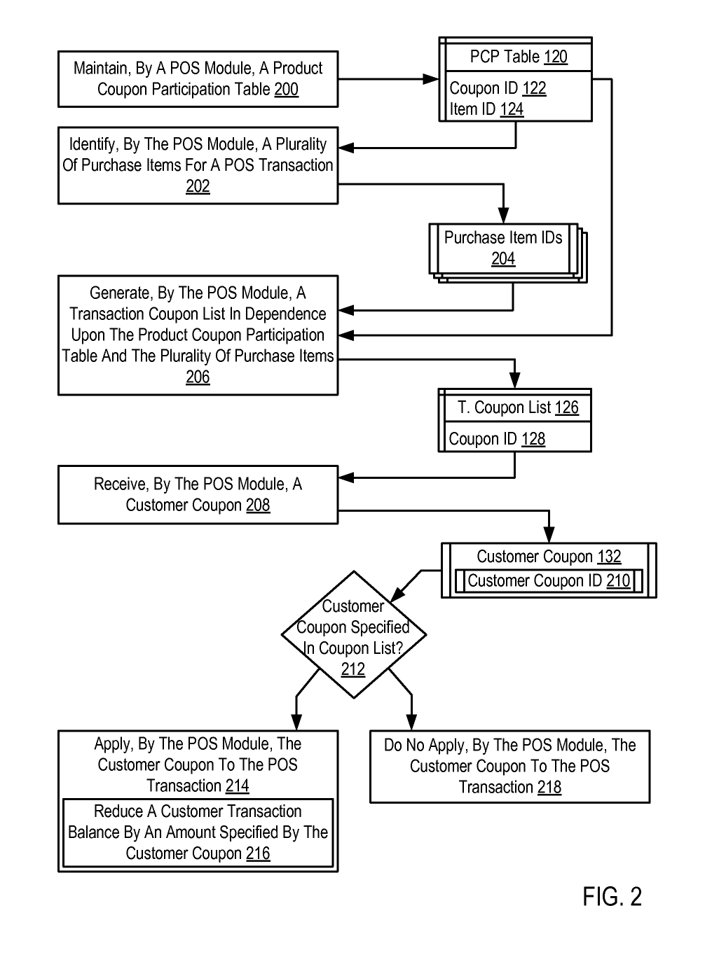

For further explanation, FIG. 2 sets forth a flow chart illustrating an exemplary method of electronic coupon validation for a POS transaction according to embodiments of the present invention. The method of FIG. 2 includes maintaining (200), by a POS module, a product coupon participation table (120) that associates each of a plurality of electronic coupons with one or more items which qualify for that electronic coupon. The exemplary product coupon participation table (120) of FIG. 2 associates electronic coupons with items which qualify for the electronic coupons. Each record of the exemplary product coupon participation table (120) of FIG. 2 includes a coupon identifier field (122) and an item identifier field (124). The POS module may maintain (200) a product coupon participation table (120) according to the method of FIG. 2 by storing a coupon identifier for an electronic coupon in the coupon identifier field (122) in association with an item identifier for an item which qualifies for a price discount specified by the coupon if the coupon criteria are satisfied.

For further explanation, consider the following exemplary product coupon participation table:

TABLE 1
EXEMPLARY PRODUCT COUPON PARTICIPATION TABLE

| COUPON IDENTIFIER | PRODUCT IDENTIFIER |
|---|---|
| Softdrink_Coupon_ID | Softdrink_ID |
| Chips_Coupon_ID | Chips_ID |
| Tomato_Sauce_Coupon_ID | Tomato_Sauce_ID |
| Spaghetti_Coupon_ID | Spaghetti_ID |
| Laundry_Detergent_Coupon_ID | Laundry_Detergent_ID |
| Bleach_Coupon_ID | Bleach_ID |

The exemplary product coupon participation table above includes six records. Each record specifies an item and a coupon that provides a customer with a price discount on the item if the coupon criteria are satisfied. The first record associates an electronic coupon having an identifier ‘Softdrink_Coupon_ID’ with a soft drink having an identifier ‘Softdrink_ID.’ The second record associates an electronic coupon having an identifier ‘Chips_Coupon_ID’ with bag of chips having an identifier ‘Chips_ID.’ The third record associates an electronic coupon having an identifier ‘Tomato_Sauce_Coupon_ID’ with can of tomato sauce having an identifier ‘Chips_ID.’ The fourth record associates an electronic coupon having an identifier ‘Spaghetti_Coupon_ID’ with package of spaghetti having an identifier ‘Spaghetti_ID.’ The fifth record associates an electronic coupon having an identifier ‘Laundry_Detergent_Coupon_ID’ with box of laundry detergent having an identifier ‘Laundry_Detergent_ID.’ The sixth record associates an electronic coupon having an identifier ‘Bleach_Coupon_ID’ with bottle of bleach having an identifier ‘Bleach_ID.’ Readers will note that the exemplary product coupon participation table above s for explanation only, and not for limitation. Other product coupon participation tables in other formats as will occur to those of skill in the art may be useful in embodiments of the present invention.

The method of FIG. 2 also includes identifying (202), by the POS module, a plurality of purchase items for a POS transaction. A purchase item is an item to be purchased by customer in the POS transaction. The POS module may identify (202) a plurality of purchase items for a POS transaction according to the method of FIG. 2 by receiving purchase item identifier (204) for each of the purchase items through a POS terminal input device such as, for example, a barcode reader, RFID reader, and so on. As a customer presents the plurality of purchase items at a POS terminal to complete a POS transaction, the POS terminal may detect the identifier (204) for each of the items and provide the purchase item identifiers (204) to the POS module. For example, POS module may receive the following exemplary identifiers specifying exemplary purchase items:
Softdrink_ID
Crackers_ID
Milk_ID
Laundry_Detergent_ID
Paper_Towels_ID
Glass_Cleaner_ID
The Softdrink_ID identifies a particular soft drink. The Cracker_ID identifies a box of crackers. The Milk_ID identifies a carton of milk. The Laundry_Detergent_ID identifies a box of laundry detergent. The Paper_Towels_ID identifies a package of paper towels. The Glass_Cleaner_ID identifies a bottle of glass cleaner. Readers will note that the exemplary purchase item identifiers above are for explanation only and not for limitation.

The method of FIG. 2 also includes generating (206), by the POS module, a transaction coupon list (126) in dependence upon the product coupon participation table (120) and the plurality of purchase items. The transaction coupon list (126) of FIG. 2 represents a list that specifies the coupons that are applicable to the items being purchased by a customer in the POS transaction. The exemplary transaction coupon list (126) of FIG. 2 includes a coupon identifier field (128). The coupon identifier field (128) stores the coupon identifier for a coupon associated in the product coupon participation table (120) with an item being purchased by the customer in the POS transaction. The POS module may generate (206) the transaction coupon list (126) according to the method of FIG. 2 by retrieving the coupon identifier associated with each item identifier that matches one of the purchase item identifier (204) in the product coupon participation table (120) and storing the retrieved coupon identifiers in the transaction coupon list (126). In the method of FIG. 2 the POS module may generate (206) the transaction coupon list (126) by updating the transaction coupon list (126) after each purchase item is identified by the POS module or by creating the transaction coupon list (126) after the POS module identifies all of the purchase items.

For further explanation, consider again the exemplary product coupon participation table above and the exemplary purchase item identifiers above. Using the exemplary product coupon participation table above and the exemplary purchase item identifiers above, the POS module may generate the following exemplary transaction coupon list:

TABLE 2
EXEMPLARY
TRANSACTION COUPON LIST
COUPON IDENTIFIER
Softdrink_Coupon_ID
Laundry_Detergent_Coupon_ID

The exemplary transaction coupon list above includes two coupon identifiers. The ‘Softdrink_Coupon_ID’ coupon identifier identifies a coupon that provides a financial discount or rebate when purchasing a particular soft drink. The ‘Laundry_Detergent_Coupon_ID’ coupon identifier identifies a coupon that provides a financial discount or rebate when purchasing a laundry detergent. Readers will note that the exemplary coupon identifiers above are for explanation and not for limitation. The method of FIG. 2 includes receiving (208), by the POS module, an electronic customer coupon (132). In the example of FIG. 2, the customer coupon (132) represents an electronic coupon specified by the customer during the POS transaction and includes a customer coupon identifier (210). The POS module may receive (208) an electronic customer coupon (132) according to the method of FIG. 2 by receiving the electronic customer coupon (132) from a portable storage device of the customer such as, for example, a PDA, a keydrive, memory card, smart card, and so on. The POS module (102) may receive the electronic customer coupon (132) from the customer's portable storage device through the POS terminal (108), which establishes a data communications connection with portable storage device. In other embodiments, the POS module may receive (208) an electronic customer coupon (132) according to the method of FIG. 2 by retrieving the electronic customer coupons (132) from a network-accessible coupon repository. As mentioned above, a coupon repository serves as network-accessible storage for a customer's electronic customer coupons. The POS module may identify a particular customer's electronic coupons stored in the coupon repository using authentication credentials provided by the customer.

For further explanation, the POS module may receive an exemplary customer coupon having the following exemplary customer coupon identifier:
Softdrink_Coupon_ID

The exemplary Softdrink_Coupon_ID identifies a particular coupon specified by the customer during the POS transaction. Readers will note that the exemplary customer coupon identifier above is for explanation only and not for limitation.

The method of FIG. 2 includes determining (212), by the POS module, whether the electronic customer coupon (132) is specified in the transaction coupon list (126). The POS module may determine (212) whether the electronic customer coupon (132) is specified in the transaction coupon list (126) according to the method of FIG. 2 by traversing the transaction coupon list (126) to identify a coupon identifier that matches the customer coupon identifier (210) for the customer coupon (132). If a coupon identifier in the transaction coupon list (126) matches the customer coupon identifier (210) for the customer coupon (132), then the electronic customer coupon (132) is specified in the transaction coupon list (126). The electronic customer coupon (132) is not specified in the transaction coupon list (126), however, if a coupon identifier in the transaction coupon list (126) does not match the customer coupon identifier (210) for the customer coupon (132).

The method of FIG. 2 includes applying (214), by the POS module, the electronic customer coupon (132) to the POS transaction if the electronic customer coupon (132) is specified in the transaction coupon list (126). In the method of FIG. 2, the POS module applies (214) the electronic customer coupon (132) to the POS transaction by reducing (216) a customer transaction balance by an amount specified by the electronic customer coupon (132). A customer transaction balance is the amount of money that the customer pays for the items purchased in the POS transaction. For example, consider that the customer's transaction balance for a POS transaction is twenty dollars, that the customer purchases a soft drink, and that the customer coupon (132) specifies a financial discount of one dollar of the price of a soft drink when a customer purchases the soft drink. In such an example, the POS module may reduce the customer transaction balance from twenty dollars to nineteen dollars.

The method of FIG. 2 also includes not applying (218), by the POS module, the electronic customer coupon (132) to the POS transaction if the electronic customer coupon (132) is not specified in the transaction coupon list (126). The POS module may not apply (218) the electronic customer coupon (132) to the POS transaction according to the method of FIG. 2 by not reducing the customer transaction balance for the POS transaction.

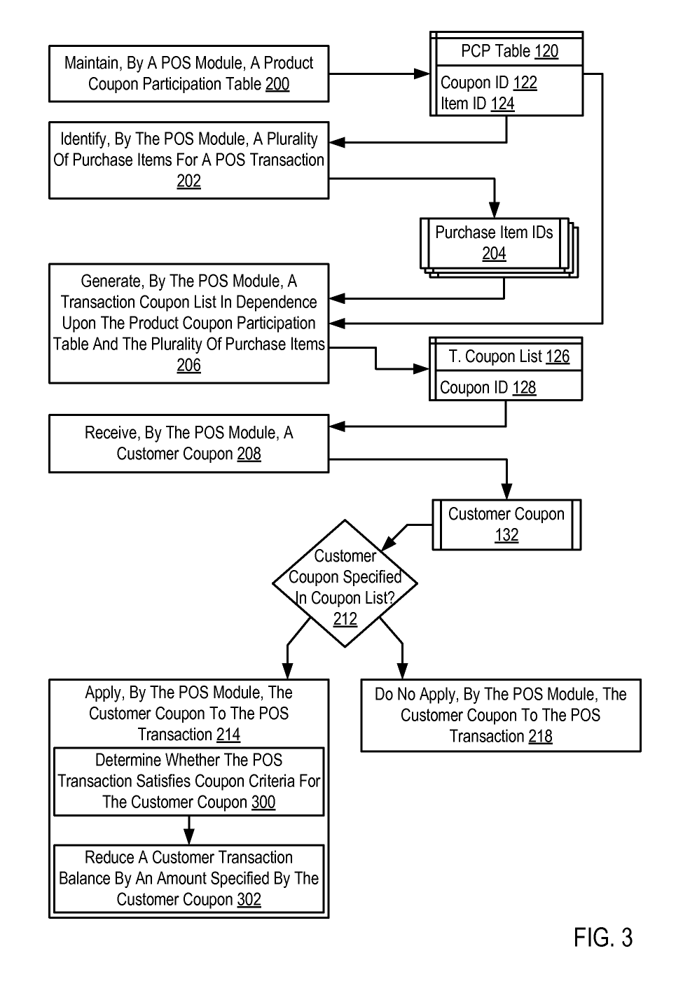

As mentioned above, the POS module may apply an electronic customer coupon to the POS transaction by reducing a customer transaction balance by an amount specified by the electronic customer coupon. In other embodiments, however, the POS module may reduce a customer transaction balance by an amount specified by the electronic customer coupon if the POS transaction satisfies certain coupon criteria. For example, consider a soft drink coupon that provides a price discount on a particular soft drink if the customer purchases a bag of chips. In such an example, the customer's transaction balance is only reduced if the customer purchases a soft drink, which qualifies for the soft drink coupon, and if the customer purchases a bag of chips as specified by the soft drink coupon criteria. For further explanation, consider FIG. 3 that sets forth a flow chart illustrating a further exemplary method of electronic coupon validation for a POS transaction according to embodiments of the present invention.

The method of FIG. 3 is similar to the method of FIG. 2. That is, the method of FIG. 3 includes: maintaining (200), by a POS module, a product coupon participation table (120) that associates each of a plurality of electronic coupons with one or more items which qualify for that electronic coupon; identifying (202), by the POS module, a plurality of purchase items for a POS transaction using purchase item identifiers (204); generating (206), by the POS module, a transaction coupon list (126) in dependence upon the product coupon participation table (120) and the plurality of purchase items; receiving (208), by the POS module, an electronic customer coupon (132); determining (212), by the POS module, whether the electronic customer coupon (132) is specified in the transaction coupon list (126); applying (214), by the POS module, the electronic customer coupon (132) to the POS transaction if the electronic customer coupon (132) is specified in the transaction coupon list (126); and not applying (218), by the POS module, the electronic customer coupon (132) to the POS transaction if the electronic customer coupon (132) is not specified in the transaction coupon list (126). The example of FIG. 3 is also similar to FIG. 2 in that the product coupon participation table (120) of FIG. 3 includes a coupon identifier field (122) and an item identifier field (124). The transaction coupon list (126) of FIG. 3 also includes a coupon identifier (128).

The method of FIG. 3 differs from the method of FIG. 2 in that applying (214), by the POS module, the electronic customer coupon (132) to the POS transaction according to the method of FIG. 3 includes determining whether the POS transaction satisfies coupon criteria for the electronic customer coupon (132) and reducing a customer transaction balance by an amount specified by the electronic customer coupon (132) if the POS transaction satisfies coupon criteria for the electronic customer coupon (132). Coupon criteria specify transaction conditions to be satisfied by a particular POS transaction before the financial benefits of a coupon may be applied to a customer's transaction balance. For example, coupon criteria may specify that a customer must purchase certain other items in addition to the item which qualifies for the coupon. In addition, coupon criteria may specify a particular date range within which the item which qualifies for the coupon must be purchased. Other coupon criteria as will occur to those of skill in the art are also well within the scope of the present invention.

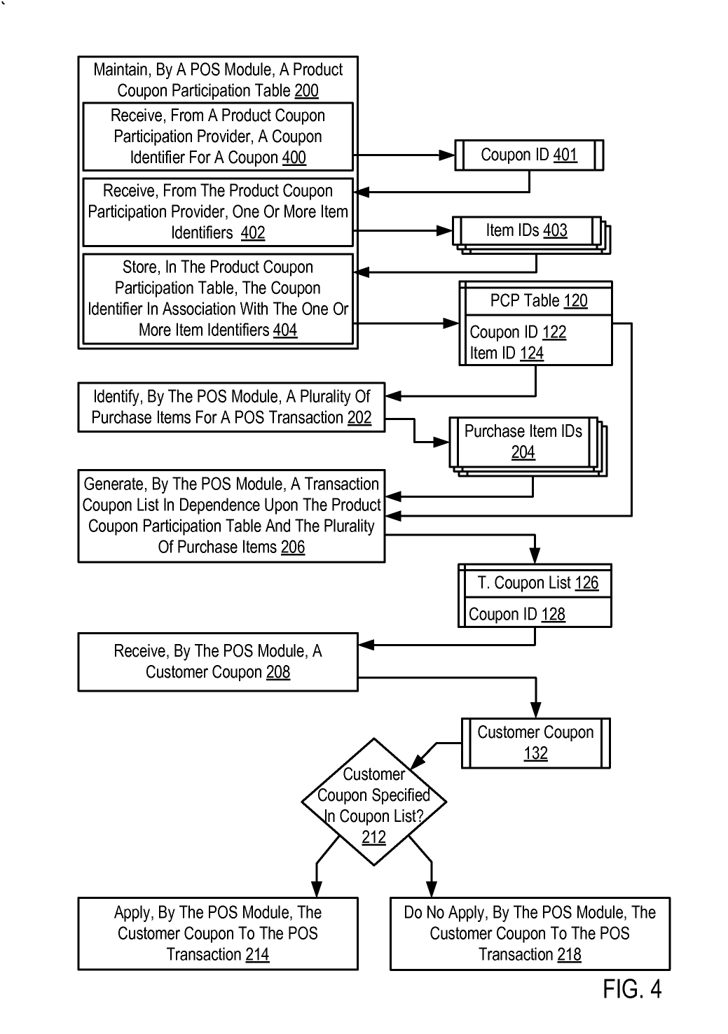

Turning now to a discussion of how a POS module may maintain a product coupon participation table, FIG. 4 sets forth a flow chart illustrating a further exemplary method of electronic coupon validation for a POS transaction according to embodiments of the present invention. The method of FIG. 4 is similar to the method of FIG. 2. That is, the method of FIG. 4 includes: maintaining (200), by a POS module, a product coupon participation table (120) that associates each of a plurality of electronic coupons with one or more items which qualify for that electronic coupon; identifying (202), by the POS module, a plurality of purchase items for a POS transaction using purchase item identifiers (204); generating (206), by the POS module, a transaction coupon list (126) in dependence upon the product coupon participation table (120) and the plurality of purchase items; receiving (208), by the POS module, an electronic customer coupon (132); determining (212), by the POS module, whether the electronic customer coupon (132) is specified in the transaction coupon list (126); applying (214), by the POS module, the electronic customer coupon (132) to the POS transaction if the electronic customer coupon (132) is specified in the transaction coupon list (126); and not applying (218), by the POS module, the electronic customer coupon (132) to the POS transaction if the electronic customer coupon (132) is not specified in the transaction coupon list (126). The example of FIG. 4 is also similar to FIG. 2 in that the product coupon participation table (120) of FIG. 4 includes a coupon identifier field (122) and an item identifier field (124). The transaction coupon list (126) of FIG. 4 also includes a coupon identifier (128).

In the method of FIG. 4, maintaining (200), by a POS module, a product coupon participation table (120) includes: receiving (400), from a product coupon participation provider, a coupon identifier (401) for an electronic coupon; receiving (402), from the product coupon participation provider, one or more item identifiers (403) for the items which qualify for the electronic coupon specified by the coupon identifier (401); and storing (404), in the product coupon participation table (120), the coupon identifier (401) in association with the one or more item identifiers (403). The product coupon participation provider is an entity that provides the information that the POS module stores in the product coupon participation table (120). The product coupon participation provider may be implemented as a coupon broker or coupon issuer. A coupon issuer is an entity that creates electronic coupons. A coupon broker is an entity that receives electronic coupons from coupon issuer and provides the coupons to customers or retail establishments. The POS module may receive the coupon identifier (401) and the item identifiers (403) from the product coupon participation provider according to the method of FIG. 4 through a data communication connection with a server controlled by the product coupon participation provider.

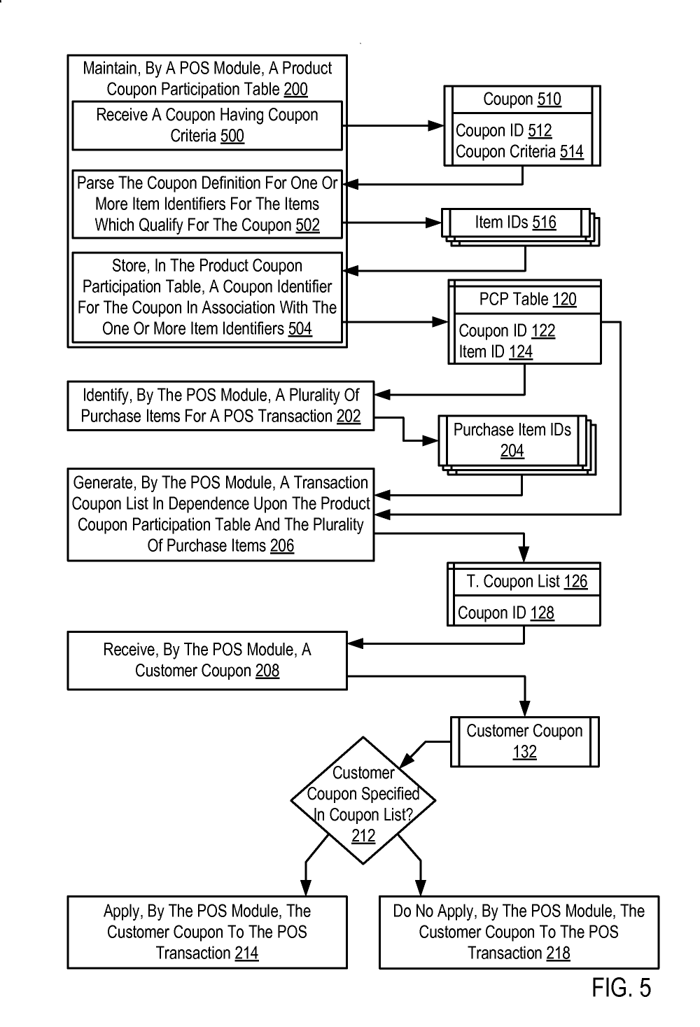

In other embodiments, the POS module may maintain a product coupon participation table by receiving copies of the electronic coupons that customers may potentially seek to apply to purchases and extracting out the information that the POS module uses for the product coupon participation table. For further explanation, consider FIG. 5 that sets forth a flow chart illustrating a further exemplary method of electronic coupon validation for a POS transaction according to embodiments of the present invention.

The method of FIG. 5 is similar to the method of FIG. 2. That is, the method of FIG. 5 includes: maintaining (200), by a POS module, a product coupon participation table (120) that associates each of a plurality of electronic coupons with one or more items which qualify for that electronic coupon; identifying (202), by the POS module, a plurality of purchase items for a POS transaction using purchase item identifiers (204); generating (206), by the POS module, a transaction coupon list (126) in dependence upon the product coupon participation table (120) and the plurality of purchase items; receiving (208), by the POS module, an electronic customer coupon (132); determining (212), by the POS module, whether the electronic customer coupon (132) is specified in the transaction coupon list (126); applying (214), by the POS module, the electronic customer coupon (132) to the POS transaction if the electronic customer coupon (132) is specified in the transaction coupon list (126); and not applying (218), by the POS module, the electronic customer coupon (132) to the POS transaction if the electronic customer coupon (132) is not specified in the transaction coupon list (126). The example of FIG. 5 is also similar to FIG. 2 in that the product coupon participation table (120) of FIG. 5 includes a coupon identifier field (122) and an item identifier field (124). The transaction coupon list (126) of FIG. 5 also includes a coupon identifier (128).

In the method of FIG. 5, maintaining (200), by a POS module, a product coupon participation table (120) includes: receiving (500) an electronic coupon (510) having coupon criteria (514); parsing (502) the coupon criteria (514) for one or more item identifiers (516) for the items which qualify for the electronic coupon (510); and storing (504), in the product coupon participation table (120), a coupon identifier (512) for the electronic coupon (510) in association with the one or more item identifiers (516). The coupon criteria (514) specify transaction conditions to be satisfied by a particular POS transaction before the financial benefits of the coupon (510) may be applied to a customer's transaction balance. For example, coupon criteria may specify that a customer must purchase certain other items in addition to the item which qualifies for the coupon. In addition, coupon criteria may specify a particular date range within which the item which qualifies for the coupon must be purchased. Other coupon criteria as will occur to those of skill in the art are also well within the scope of the present invention.

Exemplary embodiments of the present invention are described largely in the context of a fully functional computer system for electronic coupon validation for a POS transaction. Readers of skill in the art will recognize, however, that the present invention also may be embodied in a computer program product disposed on a computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of electronic coupon validation for a Point Of Sale (‘POS’) transaction, the method comprising:
maintaining, by a POS module, a product coupon participation table that associates each of a plurality of electronic coupons with one or more items which qualify for that electronic coupon;
identifying, by the POS module, a plurality of purchase items for a POS transaction;
generating, by the POS module, a transaction coupon list in dependence upon the product coupon participation table and the plurality of purchase items;
receiving, by the POS module, an electronic customer coupon;
determining, by the POS module, whether the electronic customer coupon is specified in the transaction coupon list; and
applying, by the POS module, the electronic customer coupon to the POS transaction if the electronic customer coupon is specified in the transaction coupon list.

2. The method of claim 1 where applying, by the POS module, the electronic customer coupon to the POS transaction further comprises reducing a customer transaction balance by an amount specified by the electronic customer coupon.

3. The method of claim 1 where applying, by the POS module, the electronic customer coupon to the POS transaction further comprises:
determining whether the POS transaction satisfies coupon criteria for the electronic customer coupon; and
reducing a customer transaction balance by an amount specified by the electronic customer coupon if the POS transaction satisfies coupon criteria for the electronic customer coupon.

4. The method of claim 1 where generating, by the POS module, a transaction coupon list further comprises updating the transaction coupon list after each purchase item is identified by the POS module.

5. The method of claim 1 wherein maintaining, by a POS module, a product coupon participation table that associates each of a plurality of electronic coupons with one or more items which qualify for that electronic coupon further comprises:
receiving, from a product coupon participation provider, a coupon identifier for an electronic coupon;
receiving, from the product coupon participation provider, one or more item identifiers for the items which qualify for the electronic coupon specified by the coupon identifier; and
storing, in the product coupon participation table, the coupon identifier in association with the one or more item identifiers.

6. The method of claim 1 where maintaining, by a POS module, a product coupon participation table that associates each of a plurality of electronic coupons with one or more items which qualify for that electronic coupon further comprises:
receiving an electronic coupon having coupon criteria;
parsing the coupon criteria for one or more item identifiers for the items which qualify for the electronic coupon; and
storing, in the product coupon participation table, a coupon identifier for the electronic coupon in association with the one or more item identifiers.

7. Apparatus for electronic coupon validation for a Point Of Sale (‘POS’) transaction, the apparatus comprising a computer processor, a computer memory operatively coupled to the computer processor, the computer memory having disposed within it computer program instructions capable of:
maintaining, by a POS module, a product coupon participation table that associates each of a plurality of electronic coupons with one or more items which qualify for that electronic coupon;
identifying, by the POS module, a plurality of purchase items for a POS transaction;
generating, by the POS module, a transaction coupon list in dependence upon the product coupon participation table and the plurality of purchase items;
receiving, by the POS module, an electronic customer coupon;
determining, by the POS module, whether the electronic customer coupon is specified in the transaction coupon list; and
applying, by the POS module, the electronic customer coupon to the POS transaction if the electronic customer coupon is specified in the transaction coupon list.

8. The apparatus of claim 7 where applying, by the POS module, the electronic customer coupon to the POS transaction further comprises reducing a customer transaction balance by an amount specified by the electronic customer coupon.

9. The apparatus of claim 7 where applying, by the POS module, the electronic customer coupon to the POS transaction further comprises:
determining whether the POS transaction satisfies coupon criteria for the electronic customer coupon; and
reducing a customer transaction balance by an amount specified by the electronic customer coupon if the POS transaction satisfies coupon criteria for the electronic customer coupon.

10. The apparatus of claim 7 where generating, by the POS module, a transaction coupon list further comprises updating the transaction coupon list after each purchase item is identified by the POS module.

11. The apparatus of claim 7 wherein maintaining, by a POS module, a product coupon participation table that associates each of a plurality of electronic coupons with one or more items which qualify for that electronic coupon further comprises:
receiving, from a product coupon participation provider, a coupon identifier for an electronic coupon;
receiving, from the product coupon participation provider, one or more item identifiers for the items which qualify for the electronic coupon specified by the coupon identifier; and
storing, in the product coupon participation table, the coupon identifier in association with the one or more item identifiers.

12. The apparatus of claim 7 where maintaining, by a POS module, a product coupon participation table that associates each of a plurality of electronic coupons with one or more items which qualify for that electronic coupon further comprises:
receiving an electronic coupon having coupon criteria;
parsing the coupon criteria for one or more item identifiers for the items which qualify for the electronic coupon; and
storing, in the product coupon participation table, a coupon identifier for the electronic coupon in association with the one or more item identifiers.

13. A computer program product for electronic coupon validation for a Point Of Sale (‘POS’) transaction, the computer program product disposed in a computer readable medium, the computer program product comprising computer program instructions capable of:
maintaining, by a POS module, a product coupon participation table that associates each of a plurality of electronic coupons with one or more items which qualify for that electronic coupon;
identifying, by the POS module, a plurality of purchase items for a POS transaction;
generating, by the POS module, a transaction coupon list in dependence upon the product coupon participation table and the plurality of purchase items;
receiving, by the POS module, an electronic customer coupon;
determining, by the POS module, whether the electronic customer coupon is specified in the transaction coupon list; and
applying, by the POS module, the electronic customer coupon to the POS transaction if the electronic customer coupon is specified in the transaction coupon list.

14. The computer program product of claim 13 where applying, by the POS module, the electronic customer coupon to the POS transaction further comprises reducing a customer transaction balance by an amount specified by the electronic customer coupon.

15. The computer program product of claim 13 where applying, by the POS module, the electronic customer coupon to the POS transaction further comprises:
determining whether the POS transaction satisfies coupon criteria for the electronic customer coupon; and
reducing a customer transaction balance by an amount specified by the electronic customer coupon if the POS transaction satisfies coupon criteria for the electronic customer coupon.

16. The computer program product of claim 13 where generating, by the POS module, a transaction coupon list further comprises updating the transaction coupon list after each purchase item is identified by the POS module.

17. The computer program product of claim 13 wherein maintaining, by a POS module, a product coupon participation table that associates each of a plurality of electronic coupons with one or more items which qualify for that electronic coupon further comprises:
receiving, from a product coupon participation provider, a coupon identifier for an electronic coupon;
receiving, from the product coupon participation provider, one or more item identifiers for the items which qualify for the electronic coupon specified by the coupon identifier; and
storing, in the product coupon participation table, the coupon identifier in association with the one or more item identifiers.

18. The computer program product of claim 13 where maintaining, by a POS module, a product coupon participation table that associates each of a plurality of electronic coupons with one or more items which qualify for that electronic coupon further comprises:
receiving an electronic coupon having coupon criteria;
parsing the coupon criteria for one or more item identifiers for the items which qualify for the electronic coupon; and
storing, in the product coupon participation table, a coupon identifier for the electronic coupon in association with the one or more item identifiers.

19. The computer program product of claim 13 wherein the computer readable medium comprises a recordable medium.

20. The computer program product of claim 13 wherein the computer readable medium comprises a transmission medium.
